(19) United States
(12) Patent Application Publication
(10) Pub. No.: US 2016/0148631 A1
(43) Pub. Date: May 26, 2016

(54) SLIDER WITH MICRO-PATTERNED COATING

(71) Applicant: Seagate Technology LLC, Cupertino, CA (US)

(72) Inventors: Jinhai Li, Bloomington, MN (US); David James Ellison, Minneapolis, MN (US); Robert Anthony Fernandez, Chanhassen, MN (US); Daniel Richard Buettner, Savage, MN (US)

(21) Appl. No.: 14/946,482

(22) Filed: Nov. 19, 2015

Related U.S. Application Data
(60) Provisional application No. 62/084,935, filed on Nov. 26, 2014.

(51) Int. Cl. G11B 5/60; G11B 5/187

(52) U.S. Cl. CPC G11B 5/6082; G11B 5/187

(57) ABSTRACT

A slider for a data recording device such as a disc drive. The slider has a pattern, which can be a micro-pattern, of SAM material on the air-bearing surface (ABS). The pattern comprises discrete unconnected features, such as dots or lines, that may or may no cover the entire ABS. Methods of micro-printing on the ABS are also provided.

### CROSS-REFERENCE TO RELATED APPLICATION

This application claims priority under 35 U.S.C. 119(e) to U.S. provisional application 62/084,935 filed Nov. 26, 2014, the entire disclosure of which is incorporated herein for all purposes.

### BACKGROUND

Hard disc drives are common information storage devices having a series of rotatable discs that are accessed by magnetic reading and writing elements. These data elements, commonly known as transducers, or merely as a transducer, are typically carried by and embedded in a slider that is held in a close relative position over discrete data tracks formed on a disc to permit a read or write operation to be carried out.

As distances between the slider and the disc decrease, due to the ever-growing desire to reduce the size of the disc drive and to pack more data per square inch on the disc, the potentially negative impact due to contamination on the slider increases. Unwanted contaminants on the slider can adversely affect fly height behavior, such as elevated or decreased fly height, create fly asymmetry in roll or pitch character, produce excessive modulation, and even result in undesired head-disc contact or crashing, all possibly due to contaminant build up on the slider. These flying behaviors result in degraded performance of the read or write operation of the head (e.g., skip-writes, modulated writers, weak writes, clearance stability and settling, and incorrect clearance setting).

What is needed is a mechanism to remove and/or control contaminants from between the slider and the disc surface while maintaining acceptable contact sensing between the transducer and the disc.

### SUMMARY

One particular implementation described herein is a slider having a pattern of a self-assembled monolayer (SAM) material on the air-bearing surface (ABS), the pattern comprising discrete unconnected features, such as dots or lines. In some implementations, the pattern is a micro-pattern.

Another particular implementation is a slider having SAM material on the recessed areas of the ABS, and no SAM on certain other areas of the ABS, such as the rails.

Yet another particular implementation is a method that includes forming a tool having a surface comprising protrusions and lands, applying a SAM solution on the tool surface, particularly on the lands, contacting the ABS of a slider with the SAM solution on the tool surface, and transferring the SAM solution from the tool surface to the ABS.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTIONS OF THE DRAWING

The described technology is best understood from the following Detailed Description describing various implementations read in connection with the accompanying drawings.

FIG. 1 is a perspective view of an example recording device with slider.

FIG. 2A is a perspective view of a slider with an example an air-bearing surface (ABS), FIG. 2B is a side view of the slider, and FIG. 2C is a plan view of the ABS of the slider.

FIG. 3 is a plan view of an example coating pattern on an ABS of a slider.

FIG. 4 is a plan view of another example coating pattern on an ABS of a slider.

FIG. 5 is a plan view of another example coating pattern on an ABS of a slider.

FIG. 6 is a plan view of another example coating pattern on an ABS of a slider.

FIG. 7 is a step-wise schematic depiction of a method of providing a pattern on an ABS of a slider.

### DETAILED DESCRIPTION

As discussed above, hard disc drive systems include a slider that is designed and configured to ride on an air bearing over a magnetic data storage disc. The magnetic data storage disc often includes a thin layer of lubricant in order to maintain and control the interactions of the disc and the slider. Lubricant is also present in the spindle of the disc. Lubricant, other contaminants such as dust, particles, chemicals, etc., or combinations thereof (referred to herein collectively as “contaminant(s)”) can collect on various portions of the slider, such as on the air-bearing surface (ABS), often at the trailing edge of the ABS or on the trailing edge surface of the slider. When enough collects, the contaminant forms droplets. These droplets, as they grow in size, can grow so large that they drop off of the slider onto the disc. This, is turn, can result in weak writes, weak reads, or other read-write errors.

The present disclosure is directed to sliders having a coating present as a micropattern on the ABS of the slider to control and/or direct the accumulation of contaminant on the ABS. The coating is comprised of at least one self-assembled monolayer (SAM) material. The coating is distinctly applied to various pre-determined areas of the slider ABS, for example, by a micro-contact printing process.

In the following description, reference is made to the accompanying drawing that forms a part hereof and in which are shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

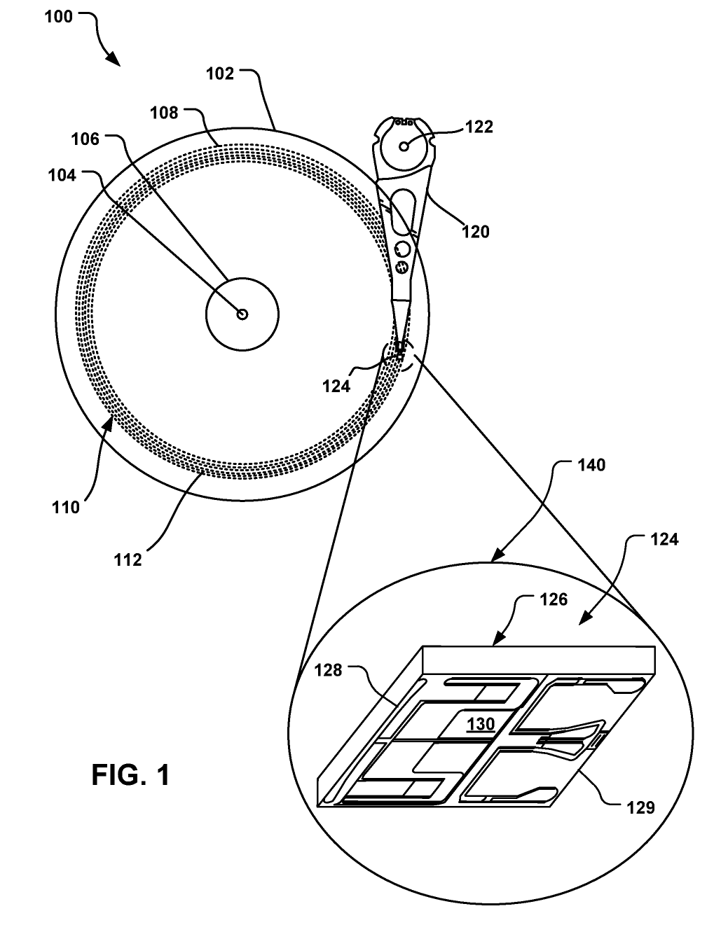

FIG. 1 illustrates a perspective view of an example recording device 100. Recording device 100 includes a disc 102, e.g., a magnetic data storage disc, which rotates about a center spindle or a disc axis of rotation 104 during operation. The disc 102 includes an inner diameter 106 and an outer diameter 108 between which are a number of concentric data tracks 110, illustrated by circular dashed lines. The data tracks 110 are substantially circular and are made up of regularly spaced bits 112, indicated as dots or ovals on the disc 102. It should be understood, however, that the described technology may be employed with other types of storage media, including continuous magnetic media, discrete track (DT) media, etc.

Information may be written to and read from the bits 112 on the disc 102 in different data tracks 110. An actuator assembly 120 having an actuator axis of rotation 122 supports a slider 124 with a transducer in close proximity above the surface of the disc 102 during disc operation. The surface of the slider 124 closest to and opposite to the disc 102 is called the air-bearing surface (ABS). In use, the actuator assembly 120 rotates during a seek operation about the actuator axis of rotation 122 to position the slider 124 over a target data track of the data tracks 110. As the disc 102 spins, a layer of air forms between the slider 124 and the surface of the disc 102, resulting in the slider 124 ‘flying’ above the disc 102. Various topographical features on the ABS of the slider 124 affect the aerodynamic properties of the slider 124 as it ‘flies’. The transducer on the slider 124 then reads or writes data to the bits 112 in the target data track 110.

An exploded view 140 illustrates an expanded view of the slider 124. The slider 124 has a body 126 with a leading edge 128 and a trailing edge 129, with an air-bearing surface (ABS) 130 between the leading edge 128 and the trailing edge 129. The ABS 130 is the surface of the slider 124 positioned opposite the surface of the disc 102 during use; that is, the ABS 130 faces the disc 102. A transducer 132 (which includes read/write head(s)) is located on or close to the trailing end 129.

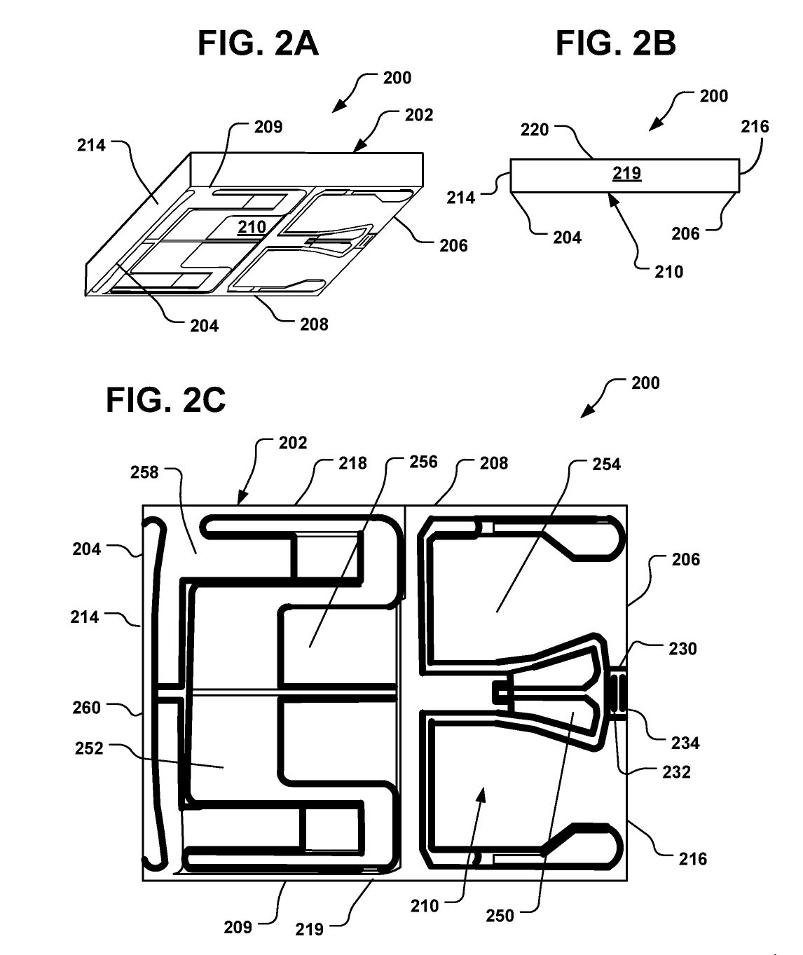

FIGS. 2A, 2B and 2C are enlarged views of a slider 200, showing various features of the slider 200. As indicated above, the slider 200 has a body 202 having a leading edge 204, a trailing edge 206 and two side edges 208, 209 connecting leading edge 204 and trailing edge 206 of body 202. These edges 204, 206, 208, 209 bound the air-bearing surface (ABS) 210. Orthogonal to the ABS 210 is a leading edge wall 214 at the leading edge 204, and similarly, at the trailing edge 206 is a trailing edge wall 216. Side edges 208, 209 have corresponding side walls 218, 219, respectively. Opposite the ABS 210 is a top surface 220. On the ABS 210 is a transducer area 230 that includes a read head 232 and a write head 234. In some implementations, the read head and the write head are in the other order.

The ABS 210 has various topological features to control the aerodynamic performance of the slider 200 as it flies over a rotating disc. The ABS 210 includes structural features such as rails, lands, ramps, depressions and the like that are designed to maximize the air-bearing surface pressure created by the stream of air flowing between the ABS 210 and the disc. In some implementations, a trench to divert and/or manage airflow is present in front of (i.e., of the leading side of) the transducer area 230. The topographical features of the ABS 210 are generally symmetrical along a center axis, from the leading edge 204 to the trailing edge 206. Although one particular implementation of a slider is illustrated in FIGS. 2A, 2B, and 2C, it is understood that the particular topographical features may have any number of various alternate configurations, which will vary depending on the size of the slider, the manufacturer, and the model or version.

In the slider 200 of FIGS. 2A, 2B and 2C, the transducer area 230 is the portion of the slider 200 that is closest to the disc when installed in a memory device, and thus the transducer area 230 has an elevation or height that can be referred to as a ‘base height’. No other portion of the ABS 210 is higher (or closer to the disc) than the base height; rather, all other portions of the ABS 210 are either even with or recessed in relation to the base height of the transducer area 230. For example, certain areas of the ABS 210 are recessed a first amount; example first recessed areas include area 250 immediately leading the transducer 230 and area 252, and example second recessed areas, which are recessed more than first recessed areas, include area 254 that extends to the trailing edge 206, area 256, and area 258. The topography of this implementation also includes a front rail 260 at the leading edge 204, the front rail 260 being an area recessed more than the second recessed areas. Not specifically identified in FIG. 2C but illustrated, the topography of the ABS 210 also includes side rails.

Many sliders, such as the slider 200, include a protective overcoat over various features of the slider 200, such as the read head 232, the write head 234, the front rail 260, the side rails, and/or the entire advanced air bearing (AAB) surface; often the protective overcoat is over the entire ABS 210. The protective overcoat may be, for example, diamond-like carbon (DLC), which has a crystal lattice similar to diamond, and/or an amorphous carbon layer. In some implementations, the protective overcoat may have a {100} crystal plane.

Present on the ABS 210, over the protective overcoat if present, is a pattern of self-assembled monolayer (SAM). The patterned coating is distinctly present on various pre-determined areas of the ABS 210 of the slider 200. In some implementations, two or more different SAM materials may form the patterned coating on the ABS 210. The pattern may be a continuous coating in a pre-determined area less than the entire ABS 210, or may be a micro-pattern, having discrete individual features, present across the entire ABS 210 or in pre-determined areas less than the entire ABS 210.

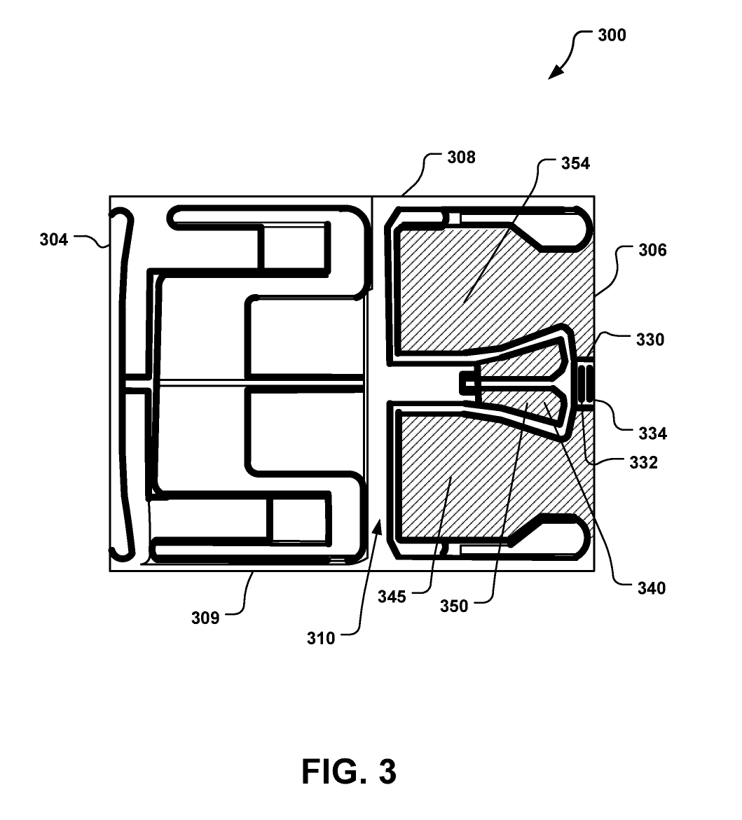

FIGS. 3 through 6, and the following discussion, provide various examples of patterns of SAMs coatings that can be present on the ABS. The coatings can be either a high surface energy coating or a low surface energy coating, comprised of at least one SAM material. In some implementations, the coatings are either oleophobic or oleophilic; the oleophobic or oleophilic property can be provided by the SAM material. The coatings are distinctly present in or on various pre-determined areas of the ABS, and are provided, for example, by a micro-contact printing process. The coating(s) are present in a location and/or pattern that directs the flow of contaminants in a desired direction and/or to a desired location, such as to the trailing edge or to a trench.

The terms “self-assembled monolayer,” “SAM,” and variants thereof, refer to a thin monolayer of surface-active molecules. The SAM molecules are provided (e.g., adsorbed and/or chemisorbed) on the surface of the slider (or the protective overcoat) from a reaction solution to produce chemical bonds therebetween.

The term “low surface energy” and variations thereof, as used herein, refers to the tendency of a surface to resist wetting (high contact angle) or adsorption by other unwanted materials or solutions. In a low surface energy SAM, the functional terminal groups of the molecules result in weak physical forces (e.g., Van der Waals forces) between the coating and liquid and thus allow for partial wetting or no wetting of the resulting coating (i.e., a high contact angle between a liquid and the coating). Conversely, “high surface energy” refers to the tendency of a surface to increase or promote wetting (low contact angle) or adsorption by other unwanted materials or solutions. In a high surface energy SAM, the functional terminal groups of molecules result in a stronger molecular force between the coating and liquid and allow for full wetting of the liquid (i.e., a very small contact angle between a liquid and the coating). If both a high surface energy coating and a low surface energy coating are present, the surface energies are relative. Values that are typically representative of “low surface energy” are in the range of 5-30 dyne/cm and high surface energy materials are relatively higher than this range, typically anything greater than 30 dyne/cm.

The phrase “oleophilic SAM” and variations thereof as used herein refers to a SAM having an oleophilic functional end group, such as saturated hydrocarbons. Other particular examples of suitable terminal groups include alkyls with 1-18 carbon atoms in addition to other unsaturated hydrocarbon variants, such as, aryl, aralkyl, alkenyl, and alkenyl-aryl. Additionally, materials with amine terminations, as well as carbon oxygen functional groups such as ketones and alcohols, will exhibit oleophilic properties.

The phrase “oleophobic SAM” and variations thereof as used herein refers to a SAM having an oleophobic functional end group, such as halosilanes and alkylsilanes. Particular examples of suitable halosilane and alkylsilane terminal groups include fluorinated and perfluorinated. In some implementations, an oleophobic SAM is also hydrophobic, thus being amphiphobic.

The precursor compound for forming a SAM coating contains molecules having a head group and a tail with a functional end group. Common head groups include thiols, silanes with hydrolizable reactive groups (e.g., halides: {F, Cl, Br, I}, and alkoxys: {methoxy, ethoxy, propoxy}, phosphonates, etc. Common tail groups include alkyls with 1-18 carbon atoms in addition to other unsaturated hydrocarbon variants, such as, aryl, aralkyl, alkenyl, and alkenyl-aryl. In addition, the hydrocarbon materials listed above can be functionalized with fluorine substitutions, amine terminations, as well as carbon oxygen functional groups such as ketones and/or alcohols, etc., depending on the desired properties of the resulting SAM coating.

SAM coatings are created by chemisorption of the head groups onto the substrate material (i.e., in this application, onto the slider body and/or protective overcoat) from either a vapor or liquid phase, by processes such as immersion or dip coating, spraying, chemical vapor deposition (CVD), micro-contact printing, dip-pen nanolithography, etc. The head groups closely assemble on the substrate with the tail groups extending away from the substrate. The self-assembled monolayer can be, for example, an organosilane (e.g. alkyl trichlorosilane, fluorinated alkyl trichlorosilane, alkyl trialkyloxysilane, fluorinated alkyl trialkyloxysilane, etc.).

The precursor compound of the SAM may be present in any conventionally-used organic solvent, water, or any mixture thereof. Examples of suitable organic solvents may include, but are not limited to, alcohols (e.g., methyl alcohol, ethyl alcohol, n-propyl alcohol, isopropyl alcohol, n-butyl alcohol, sec-butyl alcohol, t-butyl alcohol, isobutyl alcohol, and diacetone alcohol); ketones (e.g., acetone, methylethylketone, methylisobutylketone); glycols (e.g., ethyleneglycol, diethyleneglycol, triethyleneglycol, propyleneglycol, butyleneglycol, hexyleneglycol, 1,3-propanediol, 1,4-butanediol, 1,2,4-butantriol, 1,5-pentanediol, 1,2-hexanediol, 1,6-haxanediol); glycol ethers (e.g., ethyleneglycol dimethyl ether, and triethyleneglycol diethyl ether); glycol ether acetates (e.g., propylene glycol monomethyl ether acetate (PGMEA)); acetates (e.g., ethylacetate, butoxyethoxy ethyl acetate, butyl carbitol acetate (BCA), dihydroterpineol acetate (DHTA)); terpineols (e.g., trimethyl pentanediol monoisobutyrate (TEXANOL)); dichloroethene (DCE); chlorobenzene; and N-methyl-2-pyrrolidone (NMP).

The concentration of the precursor compound in the solution may be determined by those skilled in the art according to the intended applications and purposes and may be in the range of about 5 to about 20 mM. An immersion step may be performed without particular limitation and may be carried out at room temperature for about 20 to 120 minutes. Alternately, other methods may be used.

An example of a commercially available low surface energy SAM is 1H,1H,2H,2H-perfluorodecyltrichlorosilane (also known as, heptadecafluoro-1,1,2,2-tetrahydro-decyl-1-trichlorosilane) [CAS: 78560-44-8], of course, other low surface energy SAM materials could be used. In general the class of fluorinated organosilane derivatives would work as low energy SAM materials. Other examples of commercially available low surface energy SAMs include: trifluoropropyltrimethoxysilane, heneicosafluorododecyltrichlorosilane, nonafluorohexyltrimethoxysilane, methyltrichlorosilane, ethyltrichlorosilane, propyltrimethoxysilane, hexyltrimethoxysilane, n-octyltriethoxysilane, n-decyltrichlorosilane, dodecyltrichlorosilane, and octadecyltrichlorosilane.

An example of a commercially available high surface energy SAM is (3-aminopropyl)-trimethoxysilane [CAS: 13822-56-5]. Of course, other high surface energy SAM materials could be used. The general class of organosilanes with amine, alcohol, or mercapto substituents would provide for a high surface energy SAM, relative to the above. Some commercially available examples include: (3-Mercaptopropyl)trimethoxysilane, methyl 11-[dichloro(methyl)silyl]undecanoate, acetoxyethyltrichlorosilane, and vinyltriethoxysilane.

Examples of commercially available oleophilic SAM materials fall within the general class of 1-18 carbon alkylsilanes with a hydrolyzable reactive group (e.g., F, Cl, Br, and I) and alkoxys (e.g., methoxy, ethoxy, and propoxy). Such chemicals are readily available, for example, from Gelest and Sigma Aldrich, and include methyltrichlorosilane, ethyltrichlorosilane, propyltrimethoxysilane, hexyltrimethoxysilane, n-octyltriethoxysilane, n-decyltrichlorosilane, dodecyltrichlorosilane, and octadecyltrichlorosilane. In addition to the alkyl class, other functional SAMs, such as the following, are also are advantageous: 3-aminopropyltrimethoxysilane, methyl 11-[dichloro(methyl)silyl]undecanoate, acetoxyethyltrichlorosilane, vinyltriethoxysilane, and nonafluorohexyltrimethoxysilane.

Various oleophobic SAM materials are commercially available.

Turning to FIG. 3, an implementation of a slider 300 having an ABS 310 with a SAM pattern is illustrated. In this particular example, the ABS 310 has two different SAMs coatings present on discrete areas of the ABS 310.

Similar to the slider 200 of FIGS. 2A through 2C, the slider 300 has a leading edge 304, a trailing edge 306 and two side edges 308, 309 connecting the leading edge 304 and the trailing edge 306. On the ABS 310 is a transducer area 330 that includes a read head 332 and a write head 334. The topography of the ABS 310 pertinent to this example includes a first recessed area 350 immediately on the leading side of the transducer area 330 and a second recessed area 354 also on the leading side of the transducer area 330 yet extending to the trailing edge 306 and extending towards the side edges 308, 309.

A first SAM coating 340 is present in the first recessed area 350, and a second SAM coating 345 is present in the second recessed area 354. Both SAM coatings 340, 345 are continuous or essentially continuous coatings. The SAM materials of coating 350 and coating 345 are selected to produce a desired flow of contaminant (e.g., lubricant) across the ABS 310.

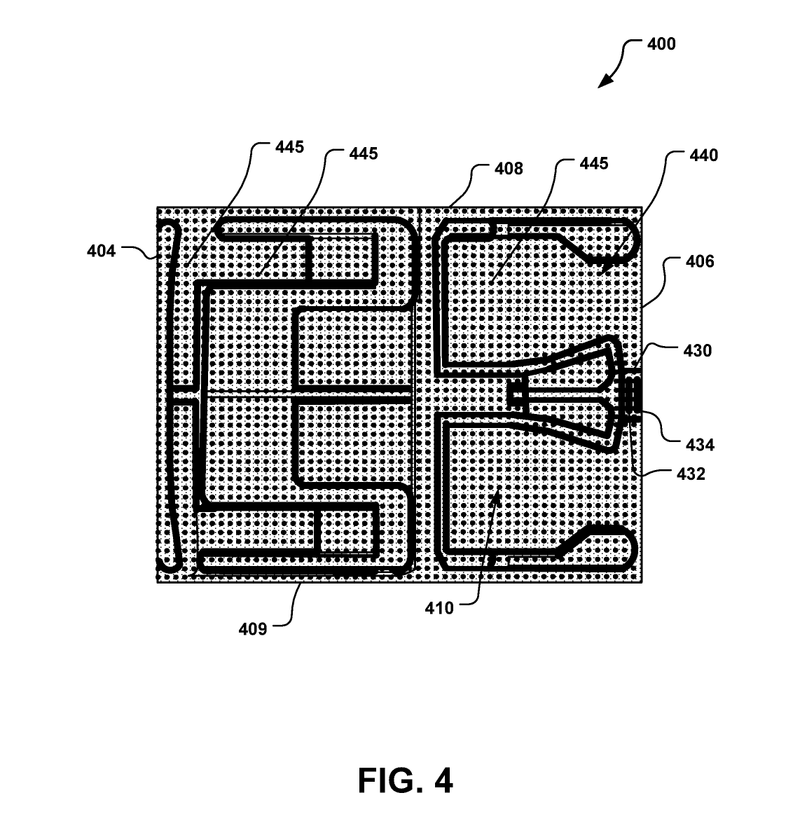

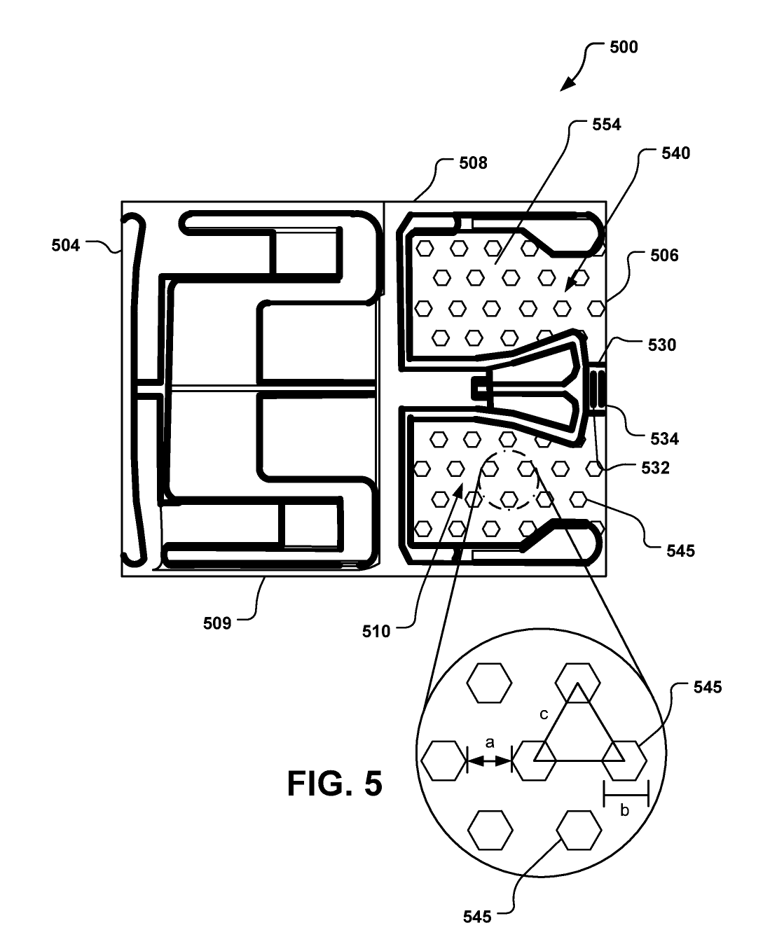

In FIGS. 4 and 5, implementations of a slider 400 and a slider 500, respectively, having a SAMs pattern, particularly a micro-pattern, are illustrated. In these particular examples, the ABS of each slider 400, 500 has a SAM coating present as a discrete, uniform pattern over the entire ABS. The pattern is referred to as a “micro-pattern”, as the pattern is composed of micrometer-sized or sub-micrometer-sized discrete units.

Similar to the sliders 200, 300, the slider 400 has a leading edge 404, a trailing edge 406 and two side edges 408, 409 connecting the leading edge 404 and the trailing edge 406. The edges 404, 406, 408, 409 bound an ABS 410. On the ABS 410 is a transducer area 430 that includes a read head 432 and a write head 434. Similarly, the slider 500 has a leading edge 504, a trailing edge 506 and two side edges 508, 509 connecting the leading edge 504 and the trailing edge 506. The edges 504, 506, 508, 509 bound an ABS 510. On the ABS 510 is a transducer area 530 that includes a read head 532 and a write head 534.

On the slider 400, a uniform SAM pattern 440 of discrete circular dots 445 is present across the entire ABS 410. On the slider 500, a uniform SAM pattern 540 of discrete hexagonal shapes 545 is present in a recessed area 554.

Examples of suitable shapes for either or both patterns 440, 540, variations thereof, and other implementations, include unconnected circular, oval/elliptical, rectangular (including square), hexagonal, pentagonal, other polygonal, and irregular shapes. In most implementations, all shapes, such as dots 445 and hexagons 545, will have the same shape and size, although in some implementations, multiple shapes and/or sizes may be used in the same pattern or coating. The discrete shapes 445, 545 may be arranged in a regular, orderly pattern or may be randomly positioned; they may be arranged in parallel rows, with the shapes 445, 545 in adjacent rows aligned to form columns orthogonal to the rows, or the rows may be offset. The shapes 445, 545 can be arranged to form a gradient that facilitates the flow of contaminant to or from the desired location.

The inset of FIG. 5 illustrates various specific features of the pattern shapes, such as the hexagonal shapes 545. As seen in the inset, individual shapes 545 have a distance “a” between perimeters or edges of adjacent shapes 545, a diameter “b” and a distance “c” between the centers of adjacent shapes 545. In some implementations, the diameter “b” is the largest dimension of the shape. In some implementations, the diameter “b” of the discrete shape is no more than 10 micrometers, in other implementations, no more than 8 micrometers, or, no more than 6 micrometers. In one particular example implementation, “a” is 4 micrometers, “b” is 8 micrometers, and “c” is 12 micrometers. In another particular example implementation, “a” is 8 micrometers, “b” is 8 micrometers, and “c” is 16 micrometers. In yet another particular example implementation, “a” is 16 micrometers, “b” is 8 micrometers, and “c” is 24 micrometers. Although these dimensions are provided for hexagonal shapes 545, they are also applicable to other shapes.

Patterns composed of discrete shapes, such as patterns 440, 540, are particularly suited for collecting (accumulating) contaminant (e.g., lubricant) in a desired location. As an example, the SAM material for patterns 440, 540 is hydrophilic and/or oleophilic. For example, if the SAM material is oleophilic, oil-based contaminants will be drawn to and coalesce on the shapes 445, 545 until the contaminant is present as a sufficiently large droplet, at which time it will be blown off from the ABS 410, 510, typically at the trailing edge of the slider.

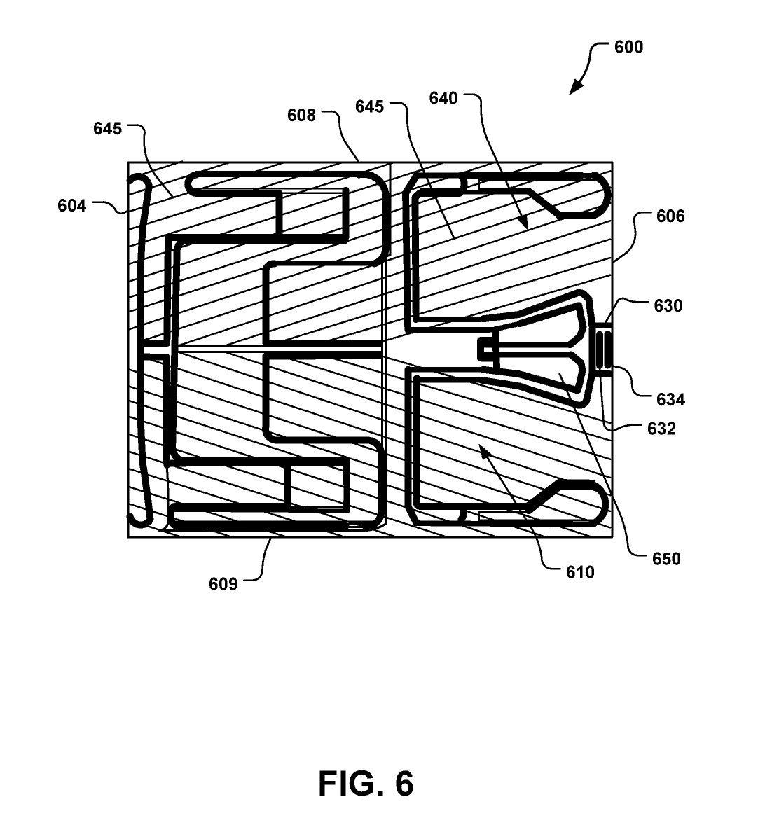

In FIG. 6, an implementation of a slider 600 with an ABS 610 having a SAM micro-pattern thereon is illustrated. In this particular example, the ABS 610 has a SAM coating present as a discrete, uniform pattern over almost the entire ABS. The pattern is referred to as a “micro-pattern”, as the pattern is composed of micrometer-sized or sub-micrometer-sized discrete, although elongate, units.

Similar to previously described sliders, the slider 600 has a leading edge 604, a trailing edge 606 and two side edges 608, 609. On the ABS 610 is a transducer area 630 that includes a read head 632 and a write head 634. The ABS 610 has a topography that includes recessed area 650 immediately in front of the transducer area 630.

On the slider 600, a uniform SAM pattern 640 of discrete lines 645 is present across a large portion of the ABS 410; the ABS 610, other than the recessed area 650 and area in close proximity to, has the pattern 640 thereon. In some implementations, the lines 645 are equally or evenly spaced across the ABS 410, so that each channel between adjacent lines 645 has the same width. In other implementations, the lines 645 are not equally spaced, but arranged to form a gradient (e.g., density gradient), for example from the leading edge 604 to the trailing edge 606.

Lined patterns, such as pattern 640, are particularly suited to direct the flow of contaminant (e.g., lubricant) to or away from a desired location. As an example, the SAM material for pattern 640 is hydrophobic and/or oleophobic. For example, if the SAM material is oleophobic, oil-based contaminants will be channeled by the lines 645 from the leading edge 604 away from the transducer 630, until the contaminant reaches the trailing edge 606, where it will drop off from the ABS 610.

Individual lines 645 have a thickness or width (the shortest or smallest dimension of the line 645) that is no more than 10 micrometers, in other implementations, no more than 8 micrometers, or, no more than 6 micrometers. The thickness or width of the lines 645 may be constant along their length or may vary. The length of the lines 645 can be any length as desired. Typically, an aspect ratio (length to width) of the lines 645 is at least 10:1, often at least 25:1 and even 50:1. Adjacent lines 645 may be parallel to each other, or not. Adjacent lines 645 may have the same or different thicknesses; the spacing between adjacent lines 645 may be the same for all adjacent lines, or may differ.

For non-continuous micro-patterns of SAM coating, such as SAM coating 440 of FIG. 4 with discrete dots 445, the SAM coating 540 of FIG. 5 with discrete shapes 545, and the SAM coating 640 of FIG. 6 with discrete lines 645, the area of the ABS covered with the patterned coating is less than 100%; that is, the patterned coating is not continuous, but areas of the coated area are without SAM coating thereof. For example, an area having a patterned coating thereon has at least 10% of its area, in some implementations at least 25% of its area, uncoated by the SAM material. In other implementations, the patterned coating may leave up to 40%, 50%, 60%, 70%, or 75% uncoated by the SAM material.

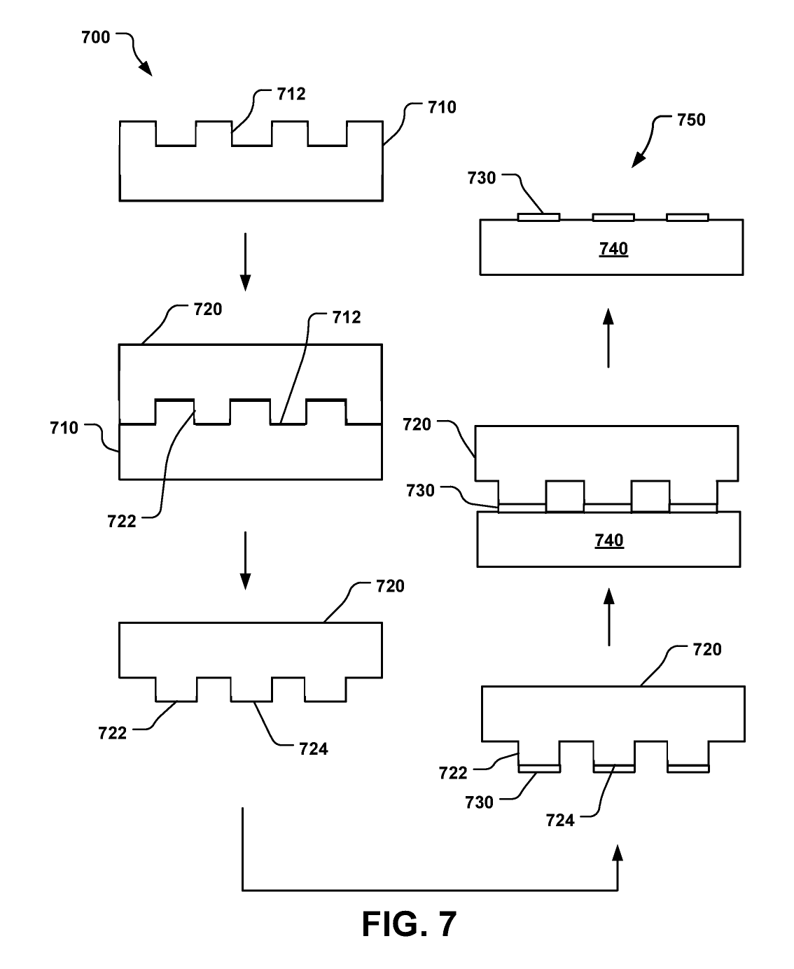

FIG. 7 illustrates schematically and step-wise a process 700 for providing a micro-pattern on a surface such as a slider. The process 700 includes first providing a master tool 710 having a plurality of cavities 712 therein; the cavities 712 should be shaped, sized and spaced as desired (or close to as desired) for the final micro-pattern. For example, the cavities 712 could be elongate cavities, so that the resulting micro-pattern will be lines, or, the cavities 712 could be individual cavities, so that the resulting micro-patter will be discrete features. This master tool 710 may be, for example, a polymeric material, e.g., a silicon material.

A polymeric mold 720 is formed by applying a layer of liquid or otherwise uncured or pliable or flowable polymer to the master tool 710 so that the cavities 712 are filled with the polymer. The polymer in the cavities 712 forms protrusions 722, which are the inverse of the cavities 712. After the polymer is cured, the mold 720 is separated from the tool 710. The mold 720 has multiple protrusions 722, each with a top surface 724 that may be planar.

In some implementations the mold 720 is flexible and/or conformable, so that when placed on the topography of a slider, the mold 720 follows the topography. In other implementations, the protrusions 722 have varying heights depending on the topography of the slider surface, to allow the top surfaces 724 of the protrusions 722 to contact the surface of the slider where desired.

A coating of SAM precursor material (e.g., in solution form) 730 is applied to the top surfaces 724 of the protrusions 722. The precursor material 730 may be further processed as needed, after which the mold 720 and material 730 are brought into contact with the surface to be printed, in this implementation, a slider 740. The mold 720 is removed, leaving the material 730 on the slider 740. The material 730 may be processed if needed (e.g., cured) to provide a micro-pattern SAM printed slider 750.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Since many implementations of the invention can be made without departing from the spirit and scope of the invention, the invention resides in the claims hereinafter appended. Furthermore, structural features of the different implementations may be combined in yet another implementation without departing from the recited claims.

What is claimed is:

1. A slider having a leading edge, a trailing edge, an air-bearing surface (ABS), and read/write heads proximate the trailing edge, the slider comprising:
a micro-pattern of SAM material on the ABS, the micro-pattern comprising discrete unconnected features.

2. The slider of claim 1, wherein the micro-pattern comprises dots and the SAM is oleophilic and/or hydrophilic.

3. The slider of claim 2, wherein the dots are circular.

4. The slider of claim 2, wherein the dots are hexagonal.

5. The slider of claim 2, wherein the dots are evenly spaced.

6. The slider of claim 2, wherein the dots have no dimension greater than 10 micrometers.

7. The slider of claim 6, wherein the dots have no dimension greater than 8 micrometers.

8. The slider of claim 6, wherein the dots have no dimension greater than 6 micrometers.

9. The slider of claim 1, wherein the micro-pattern comprises lines and the SAM is oleophobic and/or hydrophobic.

10. The slider of claim 9, wherein the lines are straight.

11. The slider of claim 9, wherein the lines are evenly spaced.

12. The slider of claim 9, wherein the lines have a thickness no greater than 10 micrometers, in some implementations no greater than 6 micrometers.

13. A slider having a leading edge, a trailing edge, an air-bearing surface (ABS) having rails and recessed areas, and read/write heads proximate the trailing edge, the slider comprising SAM material on the recessed areas of the ABS, and no SAM on certain areas, such as the rails.

14. The slider of claim 13, wherein the SAM is continuous.

15. The slider of claim 13, wherein the SAM is present as a pattern.

16. The slider of claim 15, wherein the pattern is a micro-pattern.

17. The slider of claim 16, wherein the pattern comprises discrete unconnected features.

18. The slider of claim 17, wherein the SAM is oleophilic and/or hydrophilic.

19. A method comprising:
providing a slider having an air-bearing surface (ABS);
forming a tool having a surface comprising protrusions and lands;
applying a SAM solution on the tool surface;
contacting the ABS with the SAM solution on the tool surface; and
transferring the SAM solution from the tool surface to the ABS.

20. The method of claim 19, wherein contacting the ABS comprises contacting the ABS with the protrusions of the tool surface.
